(19) United States
(12) Patent Application Publication
(10) Pub. No.: US 2026/0279101 A1
(43) Pub. Date: Sep. 17, 2026

(54) EYE TRACKING DEVICE AND METHOD OF TRACKING AN EYE ROTATION

(71) Applicant: ams-OSRAM AG, Premstaetten (AT)

(72) Inventors: Volker ZAGOLLA, Prilly (CH); Ioannis PAPADOPOULOS, Lausanne (CH)

(21) Appl. No.: 19/471,701

(22) PCT Filed: Mar. 27, 2024
(86) PCT No.: PCT/EP2024/058247

§ 371 Date: Oct. 2, 2025

(30) Foreign Application Priority Data
Apr. 5, 2023 (DE) 10 2023 108 747.9

(51) Int. Cl. G06V 40/19; G02B 27/00

(52) U.S. Cl. CPC G06V 40/19; G02B 27/0093

(57) ABSTRACT

An eye tracking device for a wearable device for mounting to a user's head is provided. The eye tracking device includes a laser source unit configured to emit a laser beam to irradiate a cornea of the user's eye; a detector unit configured to provide a signal correlated to radiation of the laser beam returning from the eye; a camera unit configured to capture an image of at least part of the eye; and a processing unit for determining a rotation of the user's eye based on signals from the detector unit and the camera unit. Further, a wearable device and an eye tracking method are provided.

### CROSS-REFERENCE TO RELATED APPLICATIONS

This application is a 371 U.S. National Phase of PCT International Patent Application No. PCT/EP2024/058247 filed on Mar. 27, 2024, which claims priority from German Patent Application No. 102023108747.9 dated Apr. 5, 2023, the disclosures of which are incorporated by reference herein in their entirety for all purposes.

### SUMMARY OF THE INVENTION

The present application relates to an eye tracking device, a wearable device including an eye tracking device and an eye tracking method.

Eye tracking can be used in many applications, for instance in augmented reality (AR) applications or virtual reality (VR) applications. For example, more efficient display systems relying on foveated rendering or pupil steering require high speed eye tracking.

In particular for high speed acquisition, camera-based eye tracking methods result in an increased power consumption and thus indirectly also an increased heat generation. Eye tracking methods relying on self-mixing interferometry, SMI, on the other hand, allow high speed acquisition rates and high sensitivity with comparably low power consumption.

However, due to the low amount of sensing points that are used in this approach, there is a risk that events that are impacting the sensor position relative to the eye are misinterpreted as eye rotation.

An object to be solved is to provide an eye tracking capability that enables high speed acquisition and high reliability at low power consumption.

This object is inter alia solved by an eye tracking device, a wearable device comprising an eye tracking device and a method of tracking an eye rotation according to the independent claims.

Further aspects and expediencies are the subject of the dependent claims.

An eye tracking device for a wearable device is specified. In particular, the eye tracking device is configured to be integrated in the wearable device for mounting to a user's head. For example, the wearable device is an AR headset, a VR headset, glasses, smart glasses or a helmet.

According to at least one embodiment of the eye tracking device, the eye tracking device comprises a laser source unit configured to emit a laser beam to irradiate at least part of an eye of the user, for example, a cornea of the user's eye. For example, the laser source unit comprises one or more laser diodes to produce one or more laser beams. For example, the laser source unit comprises a vertical cavity surface-emitting laser (VCSEL) or an array of VCSELs. VCSELs have a low threshold current and thus have a comparably low power consumption. Further, they can have small dimensions and are available at low cost. However, other laser diodes may also be used, such as edge-emitting lasers, for example, distributed feedback (DFB) lasers or distributed Bragg reflector (DBR) lasers.

For example, the laser source is configured to emit radiation with a peak wavelength in the infrared or near infrared spectral range. For example, the laser source unit is configured to emit radiation with a peak wavelength in a range from 800 nm to 1500 nm.

According to at least one embodiment of the eye tracking device, the eye tracking device comprises a detector unit. In particular the detector unit is configured to provide a signal correlated to radiation of the laser beam returning from the eye. For example, the radiation is scattered at or reflected off the cornea, or the sclera or another surface of the eye. Thus, the signal of the detector unit includes information on the eye rotation.

According to at least one embodiment of the eye tracking device, the eye tracking device comprises a camera unit configured to capture an image of the cornea. For example, the camera unit has a spatial resolution of at least 2, 500 pixels or at least 10, 000 pixels or at least 100, 000 pixels or at least 1,000, 000 pixels. Using data processing, the image allows the gaze vector to be identified and thus provides information on the eye rotation. For example, the camera unit is configured to detect radiation in the visible spectral range and/or in the infrared spectral range, in particular, in the near infrared spectral range.

For example, the camera unit is configured to capture the image while the laser source irradiates at least part of the eye, in particular, if the camera unit is sensitive in the infrared spectral range. Alternatively, the eye tracking device may include a further light source configured to illuminate at least part of the eye while the image is captured.

According to at least one embodiment of the eye tracking device, the eye tracking device comprises a processing unit for determining a rotation of the user's eye based on signals from the detector unit and the camera unit. The processing unit may be integrated into the laser source unit or into the detector unit or into the camera unit or be separate from all of these units. Thus, two different signals are available for the determination of the eye rotation.

In at least one embodiment of the eye tracking device, the eye tracking device is for a wearable device for mounting to a user's head wherein the eye tracking device comprises a laser source unit configured to emit a laser beam to irradiate at least part of the user's eye. The eye tracking device further comprises a detector unit configured to provide a signal correlated to radiation of the laser beam returning from the eye, for example, scattered at or reflected off a surface of the eye such as the cornea or the sclera. The eye tracking device further comprises a camera unit configured to capture an image of at least part of the eye, for example, the cornea. The eye tracking device further comprises a processing unit for determining a rotation of the user's eye based on signals from the detector unit and the camera unit.

For example, the detector unit is configured to provide the signal correlated to radiation of the laser beam returning from the eye at a first repetition rate and the camera unit is configured to capture the image of at least part of the eye at a second repetition rate, wherein the first repetition rate is by at least a factor of 5 higher than the second repetition rate.

With the eye tracking device, the rotation of the user's eye can be based on two different signals, thereby increasing the reliability of the determination of the rotation of the eye. For example, the determination of the rotation based on the image of the camera is less sensitive to a change of the relative position between the eye tracking device and the eye than a conventional SMI-based eye tracker. Between subsequent images, high speed tracking of the rotation can be obtained using the laser source unit together with the detector unit. As the camera unit does not have to be operated at a high repetition rate, high speed eye tracking at low power consumption can be obtained, for example, with a repetition rate of at least 100 Hz or at least 200 Hz or at least 500 Hz. In other words, the eye tracking device combines the high reliability of a camera based eye tracking with the high speed tracking capability at low power consumption of a laser based eye tracker such as an SMI eye tracker.

According to at least one embodiment of the eye tracking device, the detector unit is integrated in the laser source unit and configured to obtain a self-mixing interference signal. Self-mixing interference occurs as a portion of the laser beam irradiating the eye is reflected or scattered back, for example, reflected off the cornea or another surface of the eye into the laser cavity of the laser source unit. The interference with the original radiation of the laser source unit leads to a modulation of the laser emission characteristics. Consequently, changes in the laser emission characteristics such as laser power output, laser operation voltage or laser operation current, may provide information on the rotation of the user's eye. For example, the detector unit comprises a photodiode arranged behind or within the laser cavity in order to measure the output intensity of the laser.

For example, the photodiode and the active region of the semiconductor laser are integrated in a common semiconductor body comprising semiconductor layers formed by epitaxial growth.

### Alternatively, the Photodiode May Be Located Behind a Back

mirror of the laser cavity arranged opposite to a front mirror. Most of the radiation is emitted during operation of the laser source unit through the front mirror.

Alternatively, the signal of the detector unit may be determined from a current or voltage input to the respective laser source. Changes in these parameters likewise allow information on the eye rotation to be obtained, as these parameters are affected by self-mixing interferometry effects as well.

According to at least one embodiment of the eye tracking device, the laser source unit and the camera unit are integrated in a common module, in particular, together with the detector unit. Consequently, a single module of the eye tracking device allows different signals using different tracking approaches to be provided that can be used to determine the rotation of the eye.

According to at least one embodiment of the eye tracking device, the laser source unit is integrated in a first module and the camera unit is integrated in a second module of the eye tracking device. For example, the laser unit and the detector unit are arranged in the first module. By arranging the laser source unit and the camera unit in different modules of the eye tracking device, these modules can be positioned at different locations of the wearable device.

Further, a wearable device for mounting to a user's head is specified. In particular the wearable device comprises an eye tracking device including one or more features of the eye tracking device specified above. For example, the eye tracking device is integrated in the wearable device.

According to at least one embodiment of the wearable device, at least one of the laser source unit and the camera unit are integrated in a side part of the wearable device, the side part being configured to extend along a side of the user's head. For example, the side part is a stem (or temple) of glasses or a part of a VR or AR headset or helmet.

For example, the laser beam emitted by the laser source unit is emitted towards a lens or an eyepiece of the wearable device.

According to at least one embodiment of the wearable device, the wearable device comprises an optical element configured to redirect radiation from the eye, for example, from the cornea onto at least one of the detector unit and the camera unit. For example, the optical element is a reflective or diffractive optical element. For example, the optical element is provided at a front part of the wearable device. For example, the front part of the wearable device configured to extend parallel to a forehead of the user's head at least in regions.

According to at least one embodiment of the wearable device, the optical element is integrated in an optical element of the wearable device. For example, the optical element is a lens or an eyepiece of the wearable device.

In particular, a diffractive optical element is suitable for integration into a lens of the wearable device.

According to at least one embodiment of the wearable device, at least one of the detector unit and the camera unit are integrated in a front part of the wearable device.

For example, the front part of the wearable device extends between two side parts of the wearable device and mechanically connects these side parts to one another. For example, the front part is a frame of glasses or a VR or AR headset.

According to at least one embodiment of the wearable device, the wearable device is configured to use an image obtained by the camera unit for a further application in addition to eye tracking. For example, the further application is user identification or emotion sensing or another application that requires an image of high spatial resolution, but not necessarily high repetition rates.

Further, a method of tracking an eye rotation of a user's eye is specified. The eye tracking device and the wearable device described above are particularly suited for the method.

Consequently, features described in connection with the eye tracking device or the wearable device also apply to the method and vice versa.

In at least one embodiment of the method, the method of tracking an eye rotation includes the step of irradiating at least part of the eye with a laser beam from a laser source unit and obtaining a first signal from a detector unit correlated to radiation of the laser beam returning from the eye, for example, reflected off the cornea or another surface of the eye. The method further includes a step of obtaining an image of at least part of the eye using a camera unit. The method further includes a step of determining a rotation of the eye based on the first signal and the image.

Thus, the determination of the rotation of the eye is based on two different signals, wherein the first signal relies on radiation of laser light returning from the eye whereas the image of the camera provides a high spatial resolution.

According to at least one embodiment of the method, the step of obtaining the first signal includes obtaining a self-mixing interference signal using the detector unit. A self-mixing interference signal may be obtained at high repetition rates. For example, the signal of the detector unit is obtained at a first repetition rate of at least 100 Hz or at least 200 Hz or at least 500 Hz, for example, 1000 Hz.

The images of the eye may be obtained at a second repetition rate. For example, the second repetition rate is at least 5 Hz or at least 10 Hz and/or at most 100 Hz or at most 50 Hz or at most 30 Hz. Typically, lower repetition rates result in significantly lower power consumption of camera devices.

According to at least one embodiment of the method, the first repetition rate is higher than the second repetition rate.

For example, the first repetition rate is by at least a factor of 5 or by at least a factor of 10 higher than the second repetition rate. The comparably high first repetition rate allows high speed eye tracking to be obtained at low power consumption. The images obtained at a lower second repetition rate can provide a ground truth correction for the relative measurements of the laser-based, in particular, SMI-based, eye tracker so that high reliability of the determined rotation of the eye can be obtained. For example, the image taken by the camera unit may be used to identify positional changes between the wearable device and the user's eye.

In a conventional SMI-based eye tracking system, in contrast, such events may be misinterpreted as eye rotation.

Features described above in connection with at least one embodiment of the eye tracking device, the wearable device or the method can be combined with other features described in connection with at least one embodiment of the eye tracking device, the wearable device or the method unless the features are contradictory.

Further aspects will become apparent from the subsequent description of the exemplary embodiments in connection with the figures.

### BRIEF DESCRIPTION OF THE DRAWINGS

In the exemplary embodiments and figures similar or similarly acting constituent parts are provided with the same reference signs. Generally, only the differences with respect to the individual embodiments are described. Unless otherwise specified, the description of a part or aspect in one exemplary embodiment applies to a corresponding part or aspect in another exemplary embodiment as well.

In the figures:

FIGS. 1A and 1B show an exemplary embodiment of an eye tracking device integrated in a wearable device in a top view (FIG. 1A) and a side view (FIG. 1B) ;

FIG. 1C shows an exemplary embodiment of a module comprising a laser source unit, a detector unit and a processing unit;

FIGS. 2A and 2B show an exemplary embodiment of an eye tracking device integrated in a wearable device in a top view (FIG. 2A) and a side view (FIG. 2B) ;

FIGS. 3A and 3B show an exemplary embodiment of an eye tracking device integrated in a wearable device in a top view (FIG. 3A) and a side view (FIG. 3B) ;

FIGS. 4A and 4B show an exemplary embodiment of an eye tracking device integrated in a wearable device in a top view (FIG. 4A) and a side view (FIG. 4B) ;

FIGS. 5A and 5B show an exemplary embodiment of an eye tracking device integrated in a wearable device in a top view (FIG. 5A) and a side view (FIG. 5B) ;

FIG. 6 shows an exemplary embodiment of a method of tracking an eye rotation as a function of time in arbitrary units; and

FIG. 7A shows an example of an eye position and an associated relative eye movement as a function of time in arbitrary units, FIGS. 7B and 7C show corresponding signals obtained at different repetition rates.

### DETAILED DESCRIPTION

The elements illustrated in the figures and their size relationships among one another are not necessarily true to scale. Rather, individual elements may be represented with an exaggerated size for the sake of better representability and/or of the sake of better understanding.

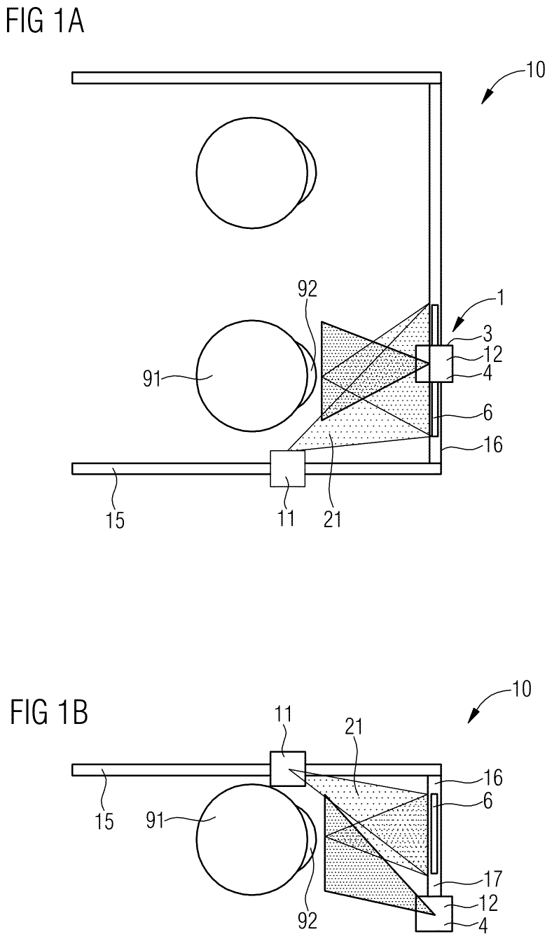

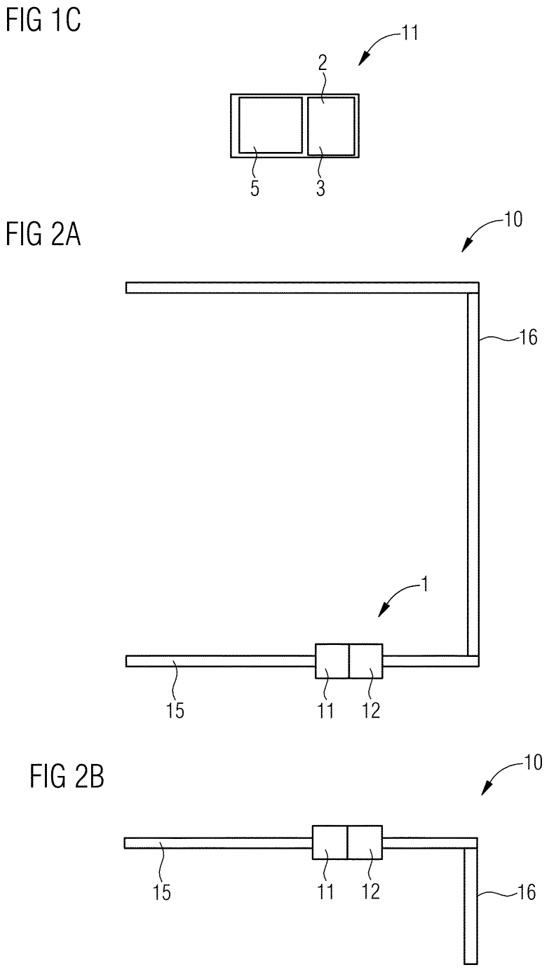

FIGS. 1A and 1B illustrate an exemplary embodiment of an eye tracking device 1 integrated in a wearable device 10 configured as glasses, for example, AR glasses or VR glasses. However, the eye tracking device 1 may also be integrated in other wearable devices such as a helmet or an AR headset or a VR headset.

The eye tracking device 1 comprises a first module 11. As illustrated in FIG. 1C, the first module may comprise a laser source unit 2 configured to emit a laser beam 21 to irradiate the cornea 92 of the user's eye 91 and a detector unit 3 configured to provide a signal correlated to reflections of the laser beam 21 off the cornea. Alternatively, in this exemplary embodiment as well as in all other exemplary embodiments, the radiation may be reflected off or scattered at another part or surface of the eye 91.

The camera unit 4 is integrated in a second module 12 of the eye tracking device 1.

In the exemplary embodiment shown in FIG. 1C, the first module 11 further comprises a processing unit 5 for determining a rotation of the user's eye 91 based on signals from the detector unit 3 and the camera unit 4.

Unlike in the exemplary embodiment shown in FIG. 1C, the processing unit 5 may also be separate from the laser source unit 2.

As shown in FIG. 1C, the detector unit 3 may be integrated in the laser source unit 2 and be configured to obtain a self-mixing interference signal. The self-mixing interference signal may be obtained from optical detection using a photodiode or by monitoring an electrical operation parameter of the laser source unit such as the operation voltage and/or the operation current. The monitored optical or electrical parameter changes based on self-mixing interference effects as the reflection off the eye 91 back into the laser resonator changes due to an eye rotation. For example, the resonator is formed by a front mirror and a back mirror of a VCSEL. The laser source unit 2 may also comprise a plurality of lasers, for example, a VCSEL array integrated in a common semiconductor laser chip, wherein the individual VCSELs of the array may be at least in part electrically contacted independently of one another.

The laser source unit 2, for example, emits radiation in the infrared or near infrared spectral range for instance at a peak wavelength in a range from 800 nm to 1500 nm, for example, at 940 nm.

For example, the processing unit 5 is configured to obtain a first signal from the detector unit at a first repetition rate and to obtain an image of the eye using the camera unit 4 at a second repetition rate. In particular, the first repetition rate can be higher than the second repetition rate, for example, by at least a factor of 5 or a factor of 10.

As the rotation of the eye 91 can be determined using two different signals, a high reliability of the determined rotation can be obtained.

The camera unit 4, for example, captures an image with a spatial resolution of at least 2, 500 pixels or at least 10, 000 pixels or at least 100, 000 pixels or at least 1, 000, 000 pixels, for example, in the visible spectral range or in the infrared spectral range, in particular, in the near infrared spectral range.

The camera unit 4 can capture images of the eye to extract the gaze vector providing information on the angular position of the eye. This can be done at a comparably low repetition rate of, for example, 30 Hz in order to obtain a low power consumption.

Optionally, the laser source unit 2 may be used to illuminate at least part of the eye 91 while the image is captured. Thus, an additional light source may be dispensed with. Alternatively, or in addition, the eye tracking device 1 or the wearable device 10 may comprise one or more further light sources, for example, one or more light emitting diodes emitting in the visible and/or infrared spectral range, in particular, in the near infrared spectral range.

Images provided by the camera unit 4 may further be used for additional applications such as user identification or emotion sensing or other applications that may need highly detailed images of at least part of the eye without requiring high repetition rates.

In the exemplary embodiment of FIGS. 1A and 1B, the first module 11 is arranged at a side part 15 of the wearable device 10 that extends along a side of the user's head. The laser beam 21 emitted by the laser source unit 2 of the first module 11 is reflected towards the eye 91 and focused by an optical element 6. For example, the optical element 6 is embodied as a diffractive optical element integrated in an optical element 17, for instance a lens, of the wearable device 10.

The second module 12 comprising the camera unit 4 is integrated in a front part 16 of the wearable device that substantially extends parallel to the user's forehead. If the wearable device 10 is embodied as glasses, the front part 16 may be a frame of the glasses and the side part 15 may be a stem or temple of the frame of the glasses.

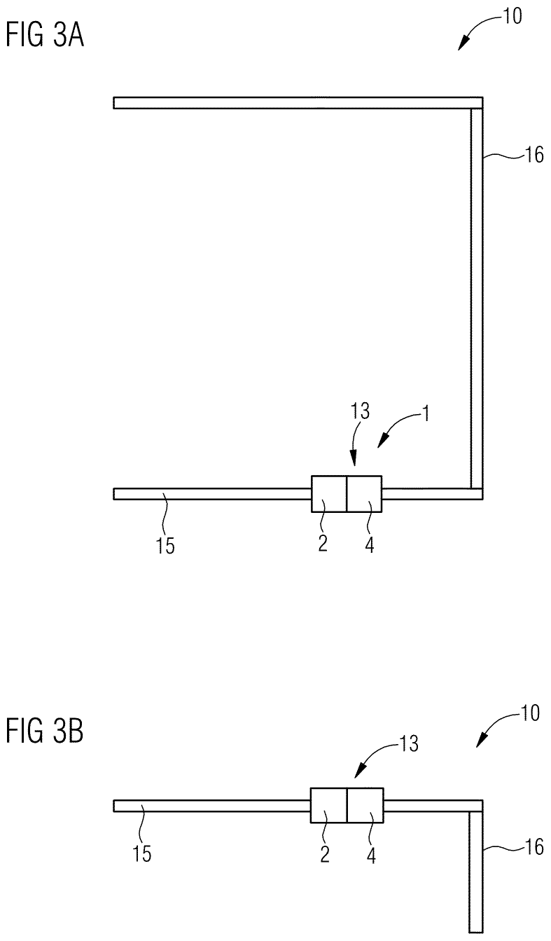

However, the first module 11 and/or the second module 12 may be located at other places of the wearable device 10. This is described in connection with FIGS. 2A through 5B.

The exemplary embodiment shown in FIGS. 2A and 2B is similar to that described in connection with FIGS. 1A to 1C. However, a difference is that the first module 11 and the second module 12 are arranged on the same part of the wearable device 10, namely on the side part 15 of the wearable device.

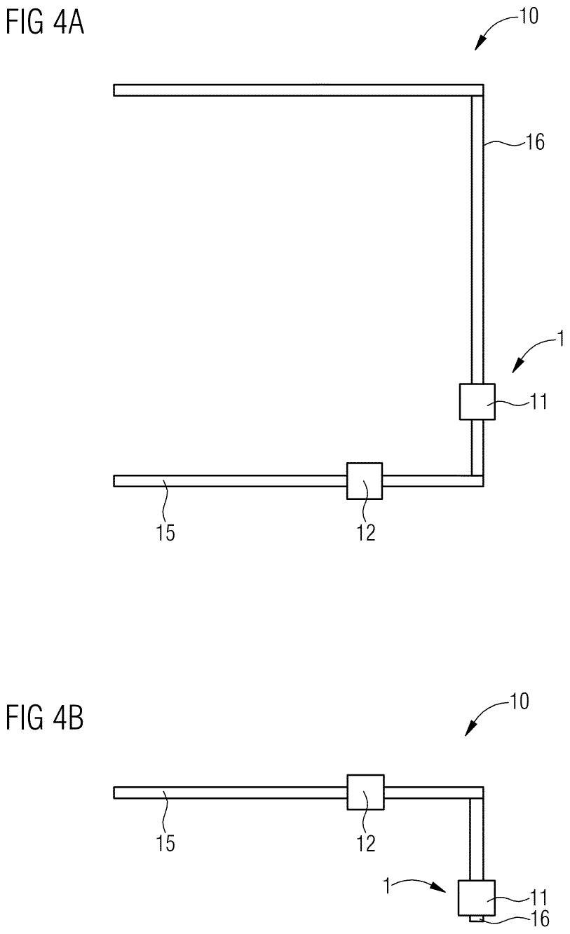

The exemplary embodiment described in connection with FIGS. 3A and 3B is similar to that described in connection with FIGS. 2A and 2B. However, a difference is that the laser source unit 2 and the camera unit 4 are integrated in a common module 13 of the eye tracking device 1. Consequently, the different functionalities resulting from the laser source unit 2 and the detector unit 3 on the one hand, and from the camera unit 4 on the other hand, may be provided by the same module of the eye tracking device 1.

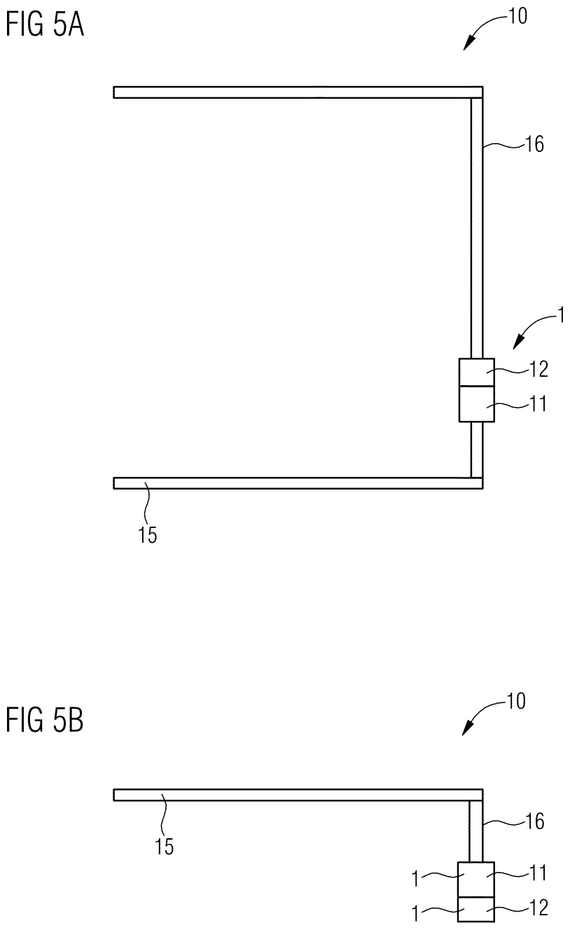

The exemplary embodiment illustrated in FIGS. 4A and 4B is similar to that described in connection with FIGS. 1A and 1B. However, a difference is that the first module 11 is arranged on the front part 16 of the wearable device 10 and the second module 12 is arranged at the side part 15 of the wearable device 10. As described in connection with FIGS. 1A and 1B, an optical element 6 may be provided in order to redirect the radiation from the eye 91 onto the camera unit 4 of the second module 12.

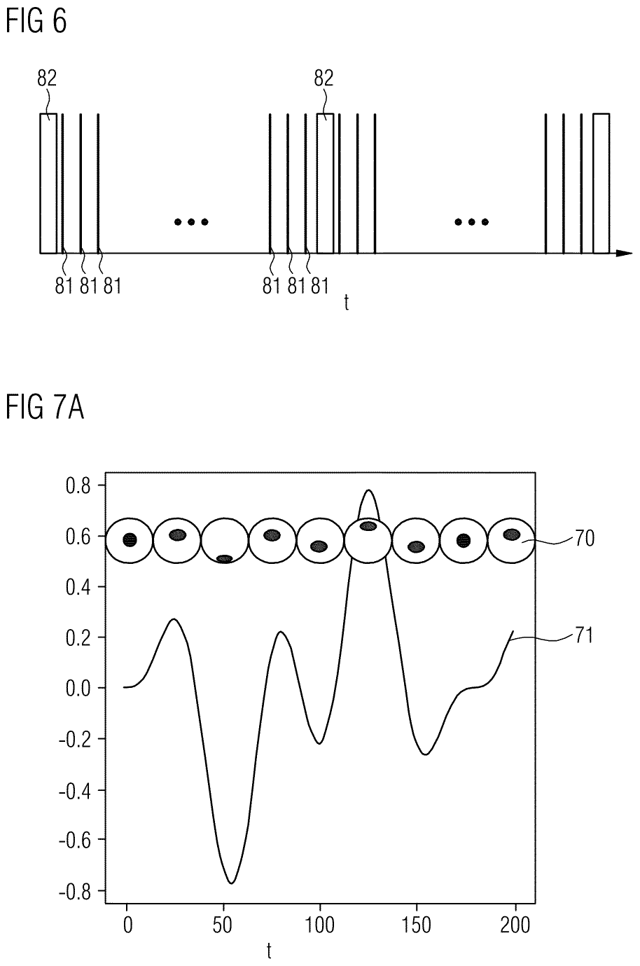

The exemplary embodiment shown in FIGS. 5A and 5B is similar to the exemplary embodiment described in connection with FIGS. 1A to 1C. However, a difference is that both the first module 11 including the laser source unit 2 and the second module 12 including the camera unit 4 are provided on the front part 16 of the wearable device 10.

In this exemplary embodiment optical elements reflecting the radiation coming from the eye may be dispensed with.

An optical element, in particular, a refractive optical element such as a lens may be integrated in at least one of the first module 11 and the second module 12. As described in connection with FIGS. 3A and 3B, the laser source unit 2 and the detector unit 3 may also be integrated in a common module and arranged in the front part 16 of the wearable device as shown in FIGS. 5A and 5B.

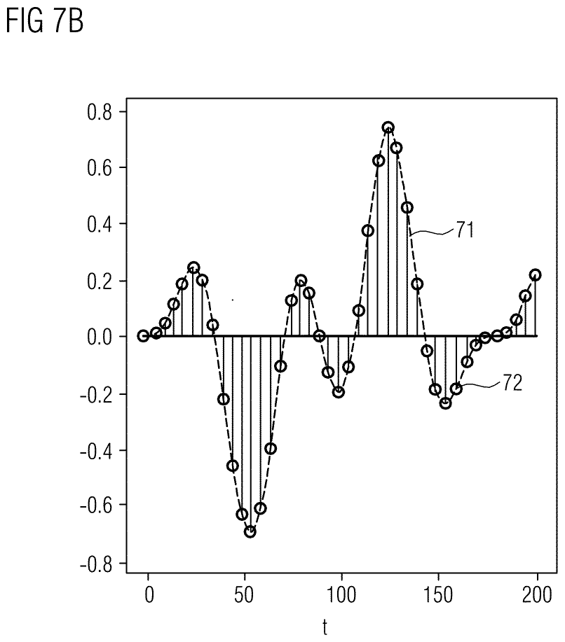

FIG. 6 illustrates an exemplary embodiment of a method of tracking an eye rotation of a user's eye wherein the signal acquisition is illustrated as a function of time.

The cornea 92 of the eye 91 is irradiated with a laser beam 21 from a laser source unit 2 and a first signal from a detector unit correlated to reflections of the laser beam 21 off the cornea 92 is obtained. This step is performed at a first repetition rate at times 81.

Further, an image of the eye 91 is obtained using a camera unit 4 at a second repetition rate at times 82. The first repetition rate is higher than the second repetition rate, for example, by a factor of at least 10.

For example, at a frequency of 30 Hz the camera unit 4 captures an image of the eye to extract the gaze vector. In between these frames that occur at a comparably low rate, the laser source unit 2 together with the detector unit 3, for example, embodied as an SMI-based eye tracking module, can provide a relative angular rotation measurement with a very fast first repetition rate of, for example, 1 KHz with a comparably low power consumption.

At the next data acquisition from the camera unit 4, the data acquired can provide a ground truth correction for the relative measurements of the, for example, SMI-based eye tracker using the laser source unit 2 and the detector unit 3.

In addition to eye tracking applications, the images obtained from the camera unit 4 can be used for an additional application such as user identification or emotion sensing.

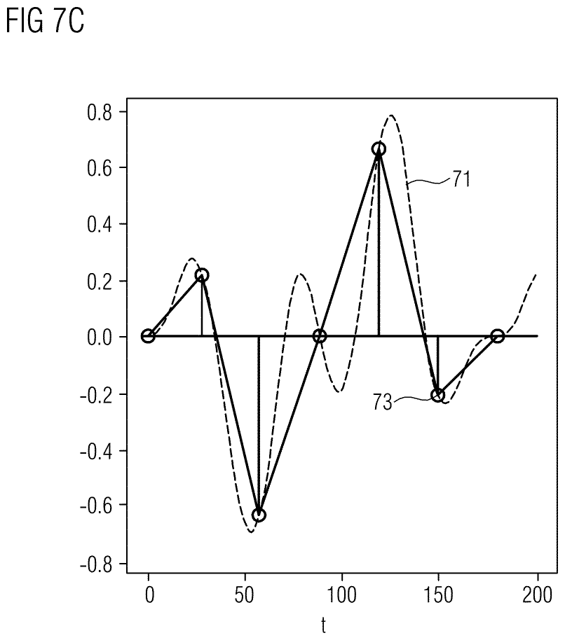

FIG. 7A illustrates an example of an eye position 70 as a function of time in arbitrary units. Curve 71 illustrates a relative eye movement in vertical direction corresponding to these eye positions 70 as a function of time. Positive values correspond to an eye rotation upwards (i.e. towards the forehead), whereas negative values correspond to an eye rotation downwards.

In FIGS. 7B and 7C, curve 71 of FIG. 7A is also shown. In addition, FIG. 7B shows a signal 72 at a comparably high repetition rate which is sufficient to reproduce the relative eye movement 71 accurately.

In FIG. 7C, in contrast, the signal 73 is acquired at a lower repetition rate, resulting in a significantly reduced accuracy of the obtained relative eye position.

FIGS. 7B and 7C illustrate that high repetition rates are required for an accurate determination of fast eye movements.

Using the approach described above, this can be reliably obtained with a low overall power consumption. Consequently, for example, the eye tracking device and the described method are particularly suited for efficient display systems using foveated rendering or pupil steering.

The invention described herein is not restricted by the description given with reference to the exemplary embodiments. Rather, the invention encompasses any novel feature and any combination of features, including in particular, any combination of features in the claims, even if this feature or this combination is not itself explicitly indicated in the claims or exemplary embodiments.

### REFERENCES

1 eye tracking device
10 wearable device
11 first module
12 second module
13 module
15 side part of wearable device
16 front part of wearable device
17 optical element of wearable device
2 laser source unit
21 laser beam
3 detector unit
4 camera unit
5 processing unit
6 optical element
70 eye position
71 relative eye movement
72 signal at high repetition rate
73 signal at low repetition rate
81 obtaining a first signal
82 obtaining an image
91 eye
92 cornea

1. An eye tracking device for a wearable device for mounting to a user's head, the eye tracking device comprising:
a laser source unit configured to emit a laser beam to irradiate at least part of an eye of the user;
a detector unit configured to provide a signal correlated to radiation of the laser beam returning from the eye at a first repetition rate;
a camera unit configured to capture an image of at least part of the eye at a second repetition rate, wherein the first repetition rate is by at least a factor of 5 higher than the second repetition rate; and
a processing unit for determining a rotation of the user's eye based on signals from the detector unit and the camera unit.

2. The eye tracking device according to claim 1,
wherein the detector unit is integrated in the laser source unit and configured to obtain a self-mixing interference signal.

3. The eye tracking device according to claim 1,
wherein the laser source unit and the camera unit are integrated in a common module

4. The eye tracking device according to claim 1,
wherein the laser source unit is integrated in a first module and the camera unit is integrated in a second module of the eye tracking device.

5. A wearable device for mounting to a user's head comprising an eye tracking device according to claim 1.

6. The wearable device according to claim 5,
wherein at least one of the laser source unit and the camera unit are integrated in a side part of the wearable device configured to extend along a side of the user's head.

7. The wearable device according to claim 5,
wherein the wearable device comprises an optical element configured to redirect radiation from the eye onto at least one of the detector unit and the camera unit

8. The wearable device according to claim 7,
wherein the optical element is integrated in an optical element of the wearable device.

9. The wearable device according to claim 8,
wherein the optical element is a diffractive optical element.

10. The wearable device according to claim 5,
wherein at least one of the detector unit and the camera unit are integrated in a front part of the wearable device configured to extend parallel to a forehead of the user's head.

11. The wearable device according to claim 5,
wherein the wearable device is configured to use an image obtained by the camera unit for a further application in addition eye tracking.

12. A method of tracking an eye rotation of a user's eye comprising the steps of:
a) irradiating at least part of the eye with a laser beam from a laser source unit and obtaining a first signal from a detector unit correlated to radiation of the laser beam returning from the eye at a first repetition rate;
b) obtaining an image of at least part of the eye using a camera unit at a second repetition rate, wherein the first repetition rate is at least by a factor of 5 higher than the second repetition rate; and
c) determining a rotation of the eye based on the first signal and the image.

13. The method according to claim 12,
wherein step a) includes obtaining a self-mixing interference signal using the detector unit.

14. The method according to claim 12,
wherein the first repetition rate is by at least a factor of 10 higher than the second repetition rate.

15. An eye tracking device for a wearable device for mounting to a user's head, the eye tracking device comprising:
a laser source unit configured to emit a laser beam to irradiate at least part of an eye of the user;
a detector unit configured to provide a signal correlated to radiation of the laser beam returning from the eye at a first repetition rate;
a camera unit configured to capture an image of at least part of the eye at a second repetition rate, wherein the first repetition rate is by at least a factor of 5 higher than the second repetition rate; and
a processing unit for determining a rotation of the user's eye based on signals from the detector unit and the camera unit;
wherein the detector unit is configured to obtain a self-mixing interference signal by monitoring an electrical operation parameter of the laser source unit.
